(19) United States
(12) Patent Application Publication
(10) Pub. No.: US 2011/0236014 A1
(43) Pub. Date: Sep. 29, 2011

(54) OPTICAL-TRANSMISSION-LINE INSPECTION APPARATUS, OPTICAL TRANSMISSION SYSTEM, AND OPTICAL-TRANSMISSION-LINE INSPECTION METHOD

(75) Inventors: Motoyoshi SEKIYA, Kawasaki (JP); Yusaku Yamamoto, Kawasaki (JP)

(73) Assignee: FUJITSU LIMITED, Kawasaki-shi (JP)

(21) Appl. No.: 12/892,432

(22) Filed: Sep. 28, 2010

(30) Foreign Application Priority Data
Sep. 28, 2009 (JP) 2009-222086

(51) Int. Cl. H04B 10/08; H04B 17/00

(52) U.S. Cl. 398/16

(57) ABSTRACT

An apparatus includes a pulse generator configured to generate a wavelet pulse defined by a setting device, an optical modulator configured to output an optical wavelet pulse based on the wavelet pulse generated by the pulse generator to an optical transmission line, and an analyzer configured to analyze a reflected wavelet pulse from the optical transmission line.

### CROSS REFERENCE TO RELATED APPLICATION

This application is based upon and claims the benefit of priority of the prior Japanese Patent Application No. 2009-222086, filed on Sep. 28, 2009, the entire contents of which are incorporated herein by reference.

### FIELD

The embodiments described herein relate to an optical-transmission-line inspection apparatus, an optical transmission system, and an optical-transmission-line inspection method.

### BACKGROUND

In administration of an optical transmission system, it is highly important to detect a state of an optical transmission line serving as a transmission medium for a light signal. To measure the state in an optical transmission line, for example, a discontinuous point in the optical transmission line, or situations, such as the number of discontinuous points, loss, and distance, are measured by inputting an optical pulse to one end of the optical transmission line and detecting reflected light from the optical transmission line. This method is widely used as an optical time domain reflectometer (OTDR) method.

A rectangular wave has hitherto been used as a pulse. However, if the optical pulse width increases, an input optical pulse and a reflected return pulse overlap, and therefore, temporal resolution is sometimes not obtained. In contrast, if the optical pulse width decreases, a sufficient SNR for the optical pulse is not obtained. As a result, it is difficult to distinguish the optical pulse. These limitations cause the necessity for making measurement a plurality of times during inspection of an optical fiber. Accordingly, for example, Japanese Unexamined Patent Application Publication No. 2008-64683, International Publication No. 04/040241, and Japanese Unexamined Patent Application Publication No. 2003-98037 disclose techniques of applying wavelet analysis to the OTDR method.

However, even with the techniques of the above publications, it is difficult to achieve both short distance and high resolution, and long distance and low resolution in one measurement operation.

### SUMMARY

According to an aspect of the invention, an apparatus includes a pulse generator configured to generate a wavelet pulse defined by a setting device, an optical modulator configured to output an optical wavelet pulse generated by the pulse generator to an optical transmission line, and an analyzer configured to analyze a reflected wavelet pulse from the optical transmission line.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF THE DRAWINGS

FIG. 1 illustrates an overall configuration of an optical-transmission-line inspection apparatus;

FIG. 2A illustrates details of a transmitter;

FIG. 2B illustrates wavelet pulse data having a waveform to which a direct-current (DC) offset is added;

FIG. 3 illustrates external modulation;

FIGS. 4A to 4C illustrate generation of a Haar wavelet;

FIGS. 5A to 5D illustrate generation of a Simlet wavelet;

FIGS. 6A and 6B illustrate a composite wavelet pulse obtained by combining the Simlet wavelets of levels 3 to 0;

FIGS. 7A to 7D explain the principle of measurement of light reflection using a wavelet pulse;

FIG. 8 illustrates details of an analyzer;

FIGS. 9A to 9D explain another principle of measurement of light reflection using a wavelet pulse;

FIGS. 10A to 10D illustrate a result of wavelet analysis;

FIGS. 11A to 11F illustrate a result of wavelet analysis;

FIG. 12 is a block diagram of an OADM node;

FIG. 13 illustrates a state in which a plurality of OADM nodes are coupled by spans; and

FIG. 14 illustrates a state in which a plurality of OADM nodes are coupled by spans.

### DESCRIPTION OF EMBODIMENTS

Embodiments will be described below with reference to the drawings.

### First Embodiment

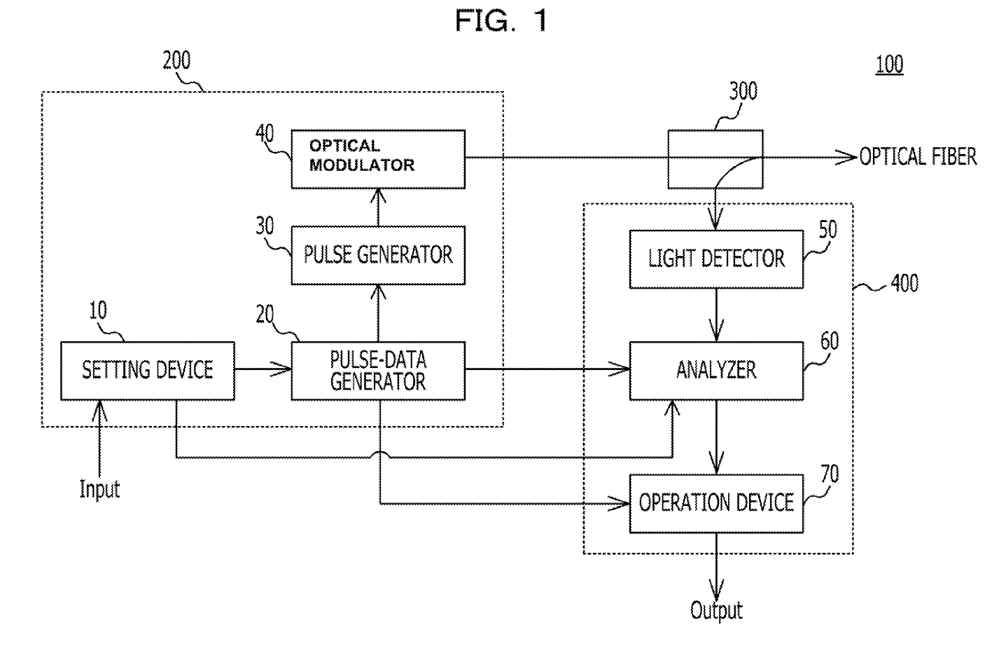

FIG. 1 illustrates an overall configuration of an optical-transmission-line inspection apparatus 100. Referring to FIG. 1, the optical-transmission-line inspection apparatus 100 includes a transmitter 200, a circulator 300, and an analyzer 400. The transmitter 200 includes a setting device 10, a pulse-data generator 20, a pulse generator 30, and an optical modulator 40. The analyzer 400 includes a light detector 50, an analyzer 60, and an operation device 70.

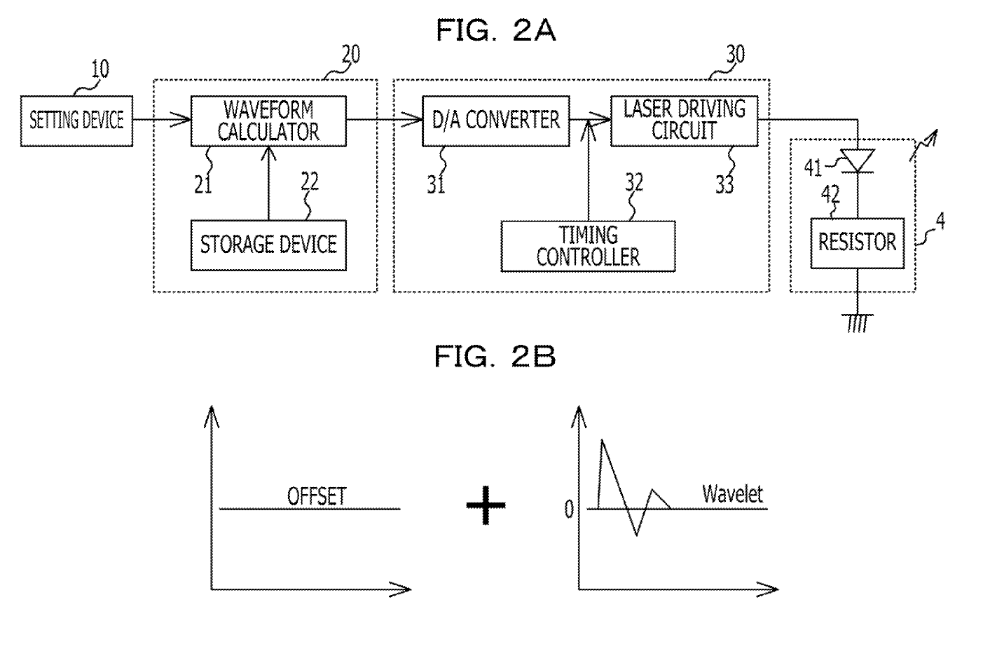

FIG. 2A illustrates details of the transmitter 200. Referring to FIG. 2A, the pulse-data generator 20 includes a waveform calculator 21 and a storage device 22. The pulse generator 30 includes a digital/analog (D/A) converter 31, a timing controller 32, and a laser driving circuit 33. The optical modulator 40 includes a laser diode 41 and a resistor 42.

Information, such as the type and order of a base wavelet, pulse time width, and wavelength of output light of the optical modulator, is input to the setting device 10. On the basis of the input information, the setting device 10 gives information necessary for generation of a designated wavelet (e.g., basic shape and order) to the pulse-data generator 20.

The pulse-data generator 20 creates wavelet pulse data on the basis of the information received from the setting device 10. More specifically, the waveform calculator 21 calculates a waveform from a parameter table stored in the storage device 22 according to the information received from the setting device 10, thereby creating wavelet pulse data. In this case, as illustrated in FIG. 2B, the waveform calculator 21 may create wavelet pulse data having a waveform to which a DC offset is added.

On the basis of the pulse data generated by the pulse-data generator 20, the pulse generator 30 modulates light output from the optical modulator 40 to generate a wavelet pulse. More specifically, the D/A converter 31 converts a digital signal received from the waveform calculator 21 into an analog signal having an analog driving waveform. The timing controller 32 controls an input timing of the analog signal from the D/A converter 31 to the laser driving circuit 33. According to the analog signal input from the D/A converter 31, the laser driving circuit 33 drives the laser diode 41 so as to modulate the light output from the laser diode 41. The type of the wavelet pulse is not limited particularly.

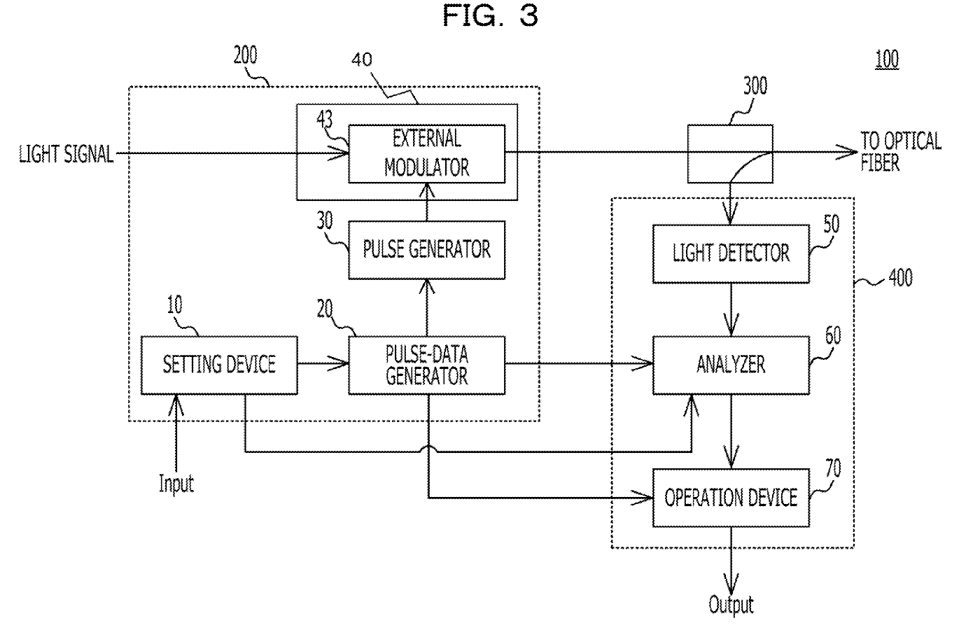

While FIG. 1 illustrates direct modulation as an example, alternatively, an external modulation method f or modulating externally input light with an external modulator (optical modulator) 43 may be adopted, as illustrated in FIG. 3. By adopting the external modulation method, it is possible to superimpose the wavelet pulse on an optical service channel (OSC) signal or a main signal.

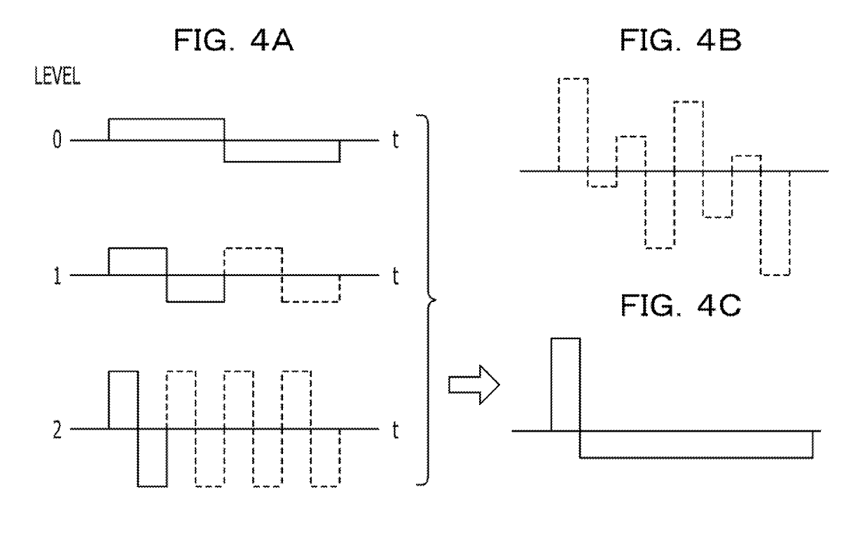

Next, a description will be given of generation of a wavelet pulse. FIGS. 4A to 4C illustrate generation of Haar wavelets. FIG. 4A illustrates Haar wavelets of levels 0 to 2. A Haar wavelet is such that, when the frequency level thereof increases by one (when the order increases by one), the amplitude is doubled and the period is reduced by half.

Referring to FIG. 4A, a wavelet of level 1 has half the period of a wavelet of level 0, and a wavelet of level 2 has half the period of the wavelet of level 1. Further, the wavelet of level 1 has double the amplitude of the wavelet of level 0, and the wavelet of level 2 has double the amplitude of the wavelet of level 1. By synthesizing the waveforms of the wavelets of levels 0 to 2, a waveform shown in FIG. 4B is obtained. Hence, a waveform shown in FIG. 4C is obtained by extracting only the first periods of the wavelets of levels 0 to 2 whose leading edges coincide with one another and adding the periods.

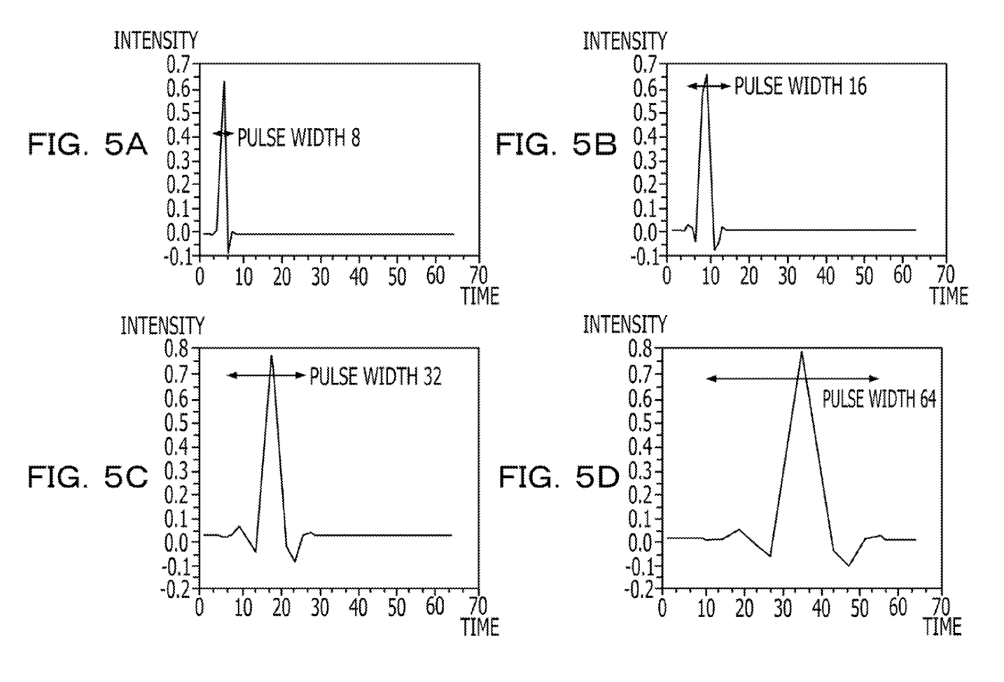

FIGS. 5A to 5D explain generation of Simlet wavelets, and illustrate Simlet wavelets having different pulse time widths. In FIGS. 5A to 5D, the horizontal axis indicates the time (arbitrary unit), and the vertical axis indicates the light intensity.

FIG. 5A illustrates a Simlet wavelet having a pulse time width of 8 (level 3), FIG. 5B illustrates a Simlet wavelet having a pulse width time of 16 (level 2), FIG. 5C illustrates a Simlet wavelet having a pulse time width of 32 (level 1), and FIG. 5D illustrates a Simlet wavelet having a pulse time width of 64 (level 0). The pulse time width represents an arbitrary time unit. Hence, as the pulse time width decreases, the frequency level increases (the order increases).

By using these wavelet pulses defined by wavelet functions, one light pulse can include a high-order component (high-frequency component) and a low-order component (low-frequency component). This achieves both short distance and high resolution, and long distance and low resolution in one measurement operation. In the embodiment, the low order and the high order represent relative levels, but are not absolute levels. Therefore, the pulse shown in FIG. 5A is a higher-order component than the pulses shown in FIGS. 5B to 5D, and the pulse shown in FIG. 5B is a higher-order component than the pulses shown in FIGS. 5C and 5D.

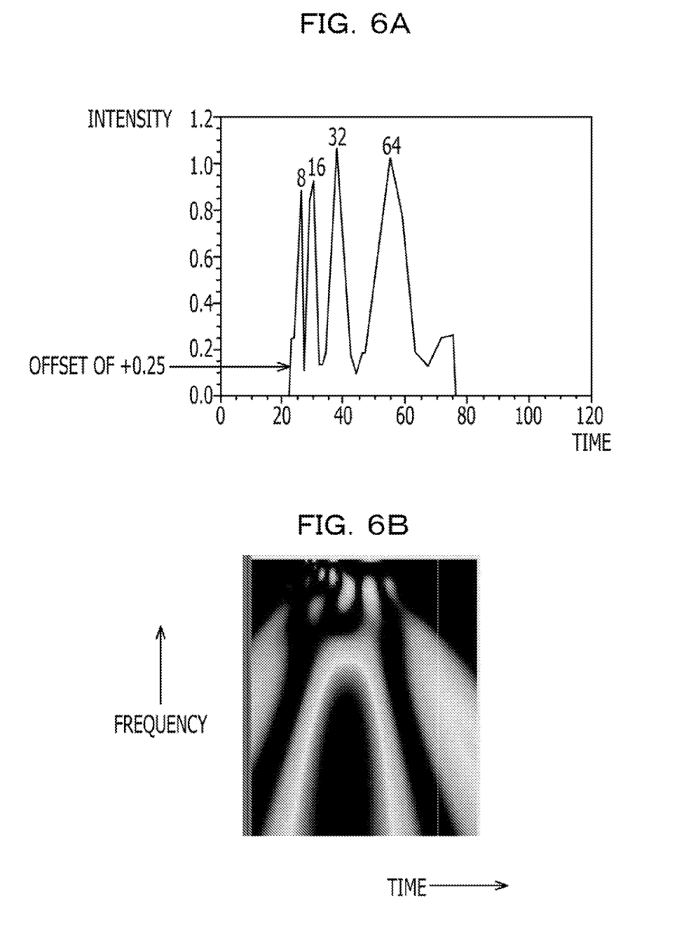

FIGS. 6A and 6B illustrate a composite wavelet pulse obtained by combining the Simlet wavelets of levels 3 to 0 shown in FIGS. 5A to 5D. FIG. 6A illustrates a waveform of a composite wavelet pulse. At each level, the peak power (peak light intensity) is set at about 1. Further, in FIG. 6A, an offset of +0.25 is set for the value in the intensity direction so as to avoid a negative amplitude.

FIG. 6B explains a result of wavelet analysis conducted on the wavelet pulse shown in FIG. 6A. In FIG. 6B, the horizontal axis indicates the time, and the vertical axis indicates the frequency (order). As shown in FIG. 6B, a low-order component (low-frequency component) and a high-order component (high-frequency component) can be separated by analyzing the wavelet pulse. Hence, short distance and high resolution can be obtained by using the high-order components, and long distance and high resolution can be obtained by using the low-order components.

From the above, short distance and high resolution, and long distance and low resolution can both be achieved in one measurement operation by conducting analysis using the wavelet pulse defined by the wavelet function.

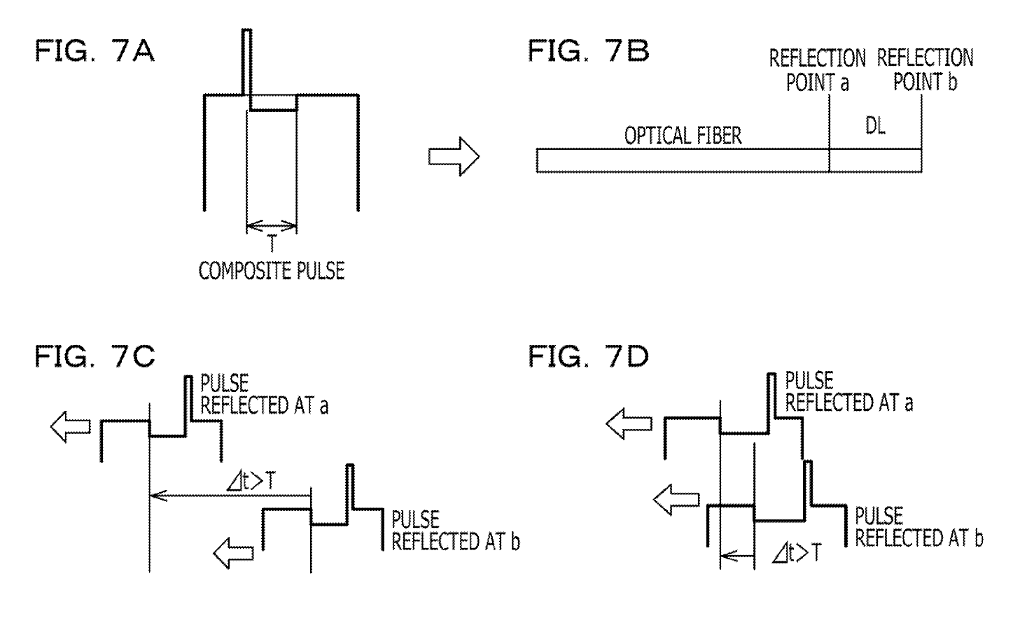

FIGS. 7A to 7D explain the principle of measurement of light reflection using a wavelet pulse. In FIGS. 7A to 7D, the composite Haar wavelet pulse shown in FIG. 4C is used as a wavelet pulse. In FIG. 7A, T represents the period of the composite wavelet pulse. As shown in FIG. 7B, a light signal on which the wavelet pulse is superimposed is input to one end of an optical transmission line such as an optical fiber. Assuming that a reflection point a and a reflection point b are produced by failure, such as a loss change, caused in the optical transmission line, a delay period DL is produced between the reflection point a and the reflection point b.

FIG. 7C explains a case in which a delay time difference Δt in the delay period DL is longer than the period T of the wavelet pulse. Here, the delay time difference Δt can be given by 2DL/c (DL: length of the delay period DL, c: velocity of light). In the case shown in FIG. 7C, the delay time difference Δt is sufficiently long, and therefore, a wavelet pulse reflected at the reflection point a does not overlap with a wavelet pulse reflected at the reflection point b. Hence, the delay time difference Δt can be found using the time difference between low-order components. As a result, the length of the delay period DL can be found. Further, since the low-order components can be used, long distance and low resolution can be obtained. Since the integrated light intensity of the wavelet pulse is fixed, similar performance can be obtained for noise.

FIG. 7D explains a case in which the delay time difference Δt in the delay period DL is shorter than the period T of the wavelet pulse. In the case shown in FIG. 7D, a low-order component of the wavelet pulse reflected at the reflection point a mutually interferes with a high-order component of the wavelet pulse reflected at the reflection point b. However, the high-order components do not mutually interfere with each other because the time widths thereof are small. Thus, the high-order components can be used, and therefore, short distance and high resolution can be obtained.

As described above, since one wavelet pulse includes a high-order component and a low-order component having different time widths, it is possible to obtain a resolution less than or equal to the total pulse width by one pulse.

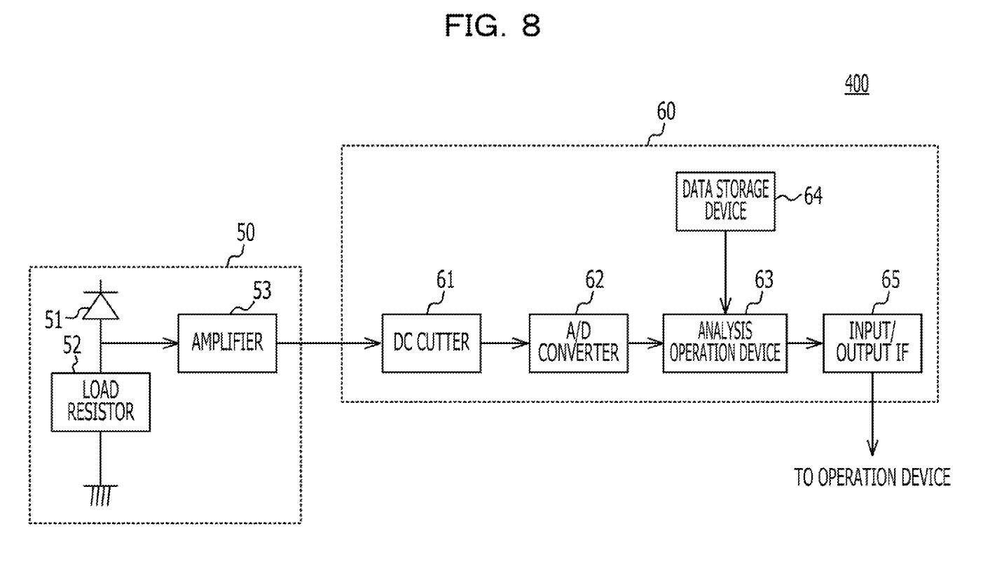

FIG. 8 is a block diagram illustrating details of the analyzer 400. Referring to FIG. 8, the light detector 50 includes a light receiving element 51, a load resistor 52, and an amplifier 53. The analyzer 60 includes a DC cutter 61, an analog/digital (A/D) converter 62, an analysis operation device 63, a data storage device 64, and an input/output interface (IF) 65.

A light signal reflected in the delay period DL of the optical transmission line is input to the light receiving element 51 via the circulator 300 shown in FIG. 1. The light receiving element 51 photoelectrically converts the received light signal into an electric signal, and transmits the electric signal to the amplifier 53. The amplifier 53 amplifies and transmits the received electric signal to the DC cutter 61.

The DC cutter 61 removes a direct-current component from the received electric signal, and transmits the electric signal to the A/D converter 62. The A/D converter 62 performs analog-to-digital conversion, and transmits a digital signal obtained by conversion to the analysis operation device 63. The data storage device 64 stores the pulse data generated by the pulse-data generator 20. On the basis of the pulse data stored in the data storage device 64, the analysis operation device 63 conducts wavelet analysis. The input/output IF 65 outputs an analysis result from the analysis operation device 63 to an external device. While the analyzer 400 receives an optical waveform in the embodiment, for example, it may receive an electric waveform. This is effective when the pulse transmitted by the transmitter 200 is used a reference.

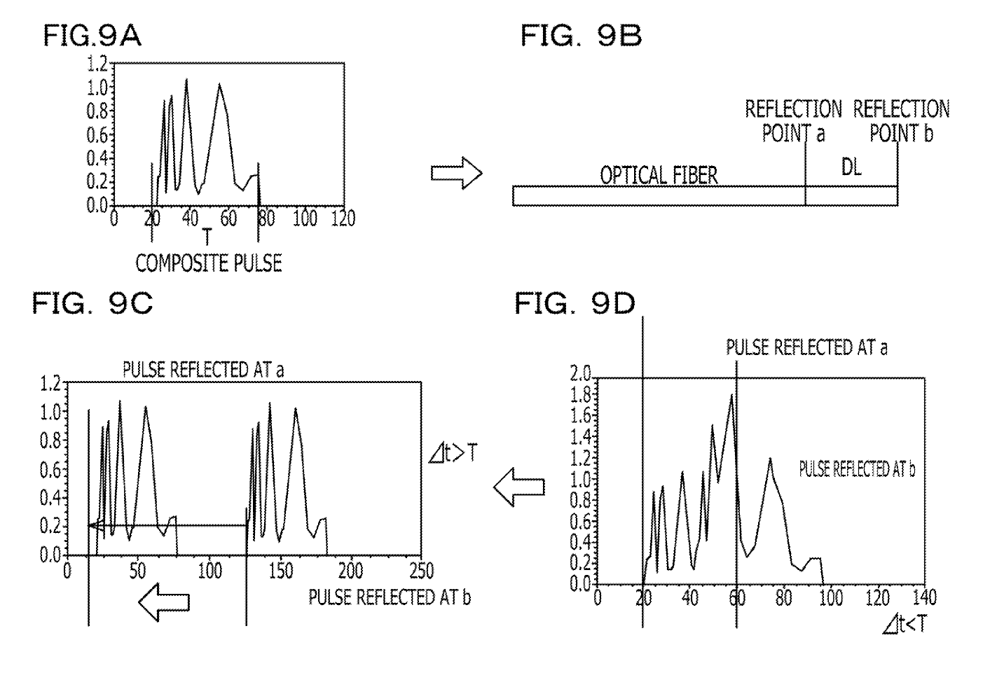

FIGS. 9A to 9D explain another principle of measurement of light reflection using a wavelet pulse. In FIGS. 9A to 9D, the composite Simlet wavelet pulse shown in FIG. 5E is used as a wavelet pulse. In FIG. 9A, T represents the period of the composite wavelet pulse. As shown in FIG. 9B, a light signal on which the wavelet pulse is superimposed is input to one end of an optical transmission line.

FIG. 9c explains a case in which a delay time difference Δt in a delay period DL is longer than the period T of the wavelet pulse. In the case shown in FIG. 9C, the delay time differenceΔt is sufficiently long, and therefore, a wavelet pulse reflected at a reflection point a does not overlap with a wavelet pulse reflected at a reflection point b. Hence, the delay time difference Δt can be obtained using the time difference between low-order components. As a result, the length of the delay period DL can be found.

FIG. 9D explains a case in which the delay time difference Δt in the delay period DL is shorter than the period T of the wavelet pulse. In the case shown in FIG. 9D, a low-order component of the wavelet pulse reflected at the reflection point a mutually interferes with a high-order component of the wavelet pulse reflected at the reflection point b. However, the high-order components do not mutually interfere with each other because the time widths thereof are small. Therefore, the delay period and the delay distance can be separated by extracting the high-order components.

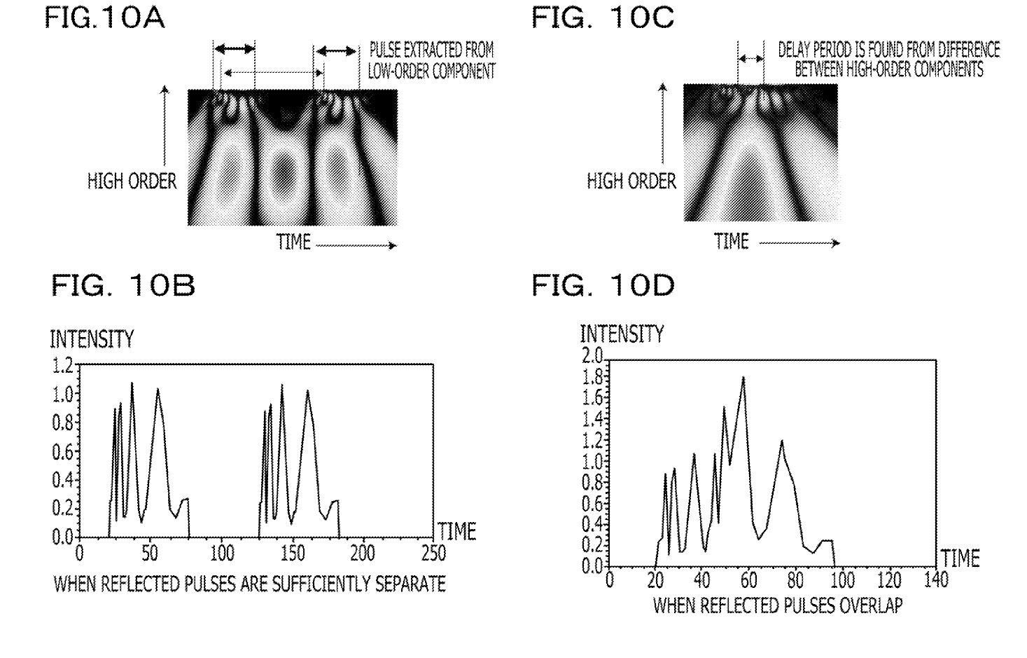

FIG. 10A to 10D explain a result of wavelet analysis. FIGS. 10A and 10B explain an analysis result obtained when the delay time difference Δt in the delay period DL is longer than the period T of the wavelet pulse. FIGS. 10C and 10D explain an analysis result obtained when the delay time difference Δt in the delay period DL is shorter than the period T of the wavelet pulse. In FIGS. 10A to 10D, the horizontal axis indicates the time. The vertical axis in FIGS. 10A and 10C indicates the frequency (order), and the vertical axis in FIGS. 10B and 10D indicate the light intensity.

As shown in FIGS. 10A to 10D, noise is removed and separation between a low-order component and a high-order component is clarified by performing wavelet analysis. When wavelet pulses are sufficiently separate from each other, as shown in FIG. 10B, low-order components do not overlap, and high-order components do not overlap, as shown in FIG. 10A. Therefore, the delay period can be found with attention to the low-order components, and a high SNR can be thereby maintained. In contrast, when the wavelet pulses overlap with each other, as shown in FIG. 10D, low-order components overlap with each other, as shown in FIG. 10C. However, since high-order components do not overlap with each other, as shown in FIG. 10C, the delay period can be found with attention to the high-order components. That is, a high time resolution can be obtained. By thus performing wavelet analysis, a high time resolution and a high SNR can both be obtained with one pulse.

According to this embodiment, short distance and high resolution, and long distance and low resolution can both be achieved by outputting a wavelet pulse formed by a wavelet function to the optical transmission line and analyzing reflected pulses of the wavelet pulse. Further, noise is removed and separation between the low-order component and the high-order component is clarified by conducting wavelet analysis on the reflected pulses. This allows a high time resolution and a high SNR to be achieved in one measurement operation.

Modification

To make the separation between the pulse components of different orders more clear, it is preferable to increase the peak power of a pulse component having a smaller time width. In this case, the peak power of the high-order component is larger than the peak power of the low-order component. This allows high-order components to be easily separated even when reflected wavelet pulses overlap with each other.

For example, in each pulse component, the value (light intensity of pulse component)×(time width of pulse component) may be fixed. In this case, the peak power is set to half every time the order decreases by one. However, it is not always necessary to use pulse components of succeeding orders. For example, it is only necessary to include at least arbitrary two of 0 to n orders (n is an arbitrary positive number). In this case, the time width of the n-order pulse component is 2n times the time width of the 0-order pulse component.

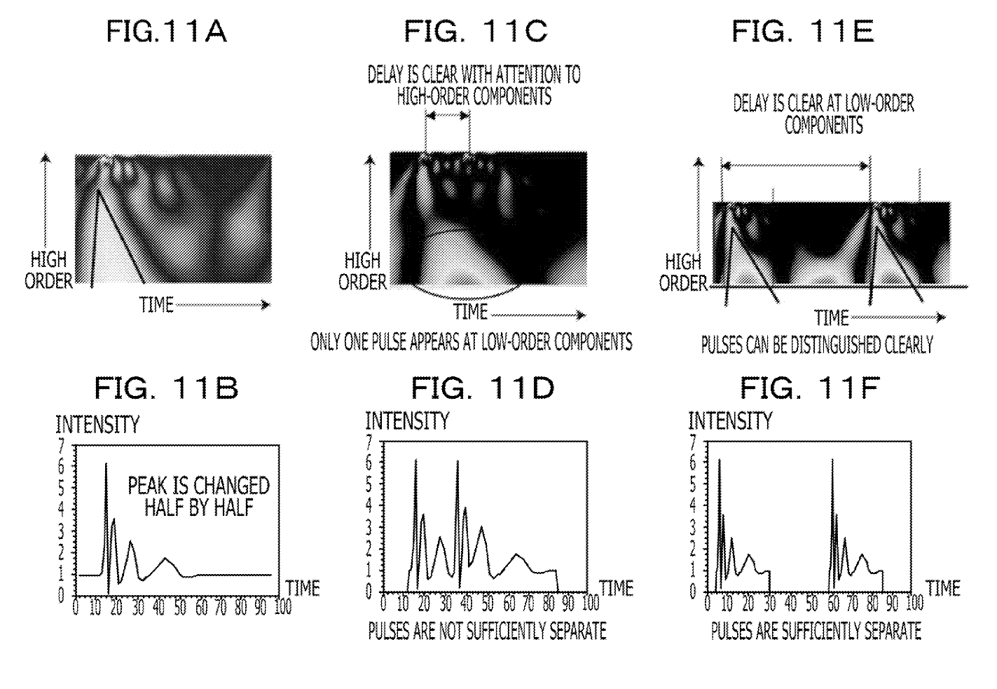

FIGS. 11A and 11B explain a composite wavelet pulse whose high-order component has a peak power set to be larger than the peak power of a low-order component. FIGS. 11C and 11D explain an analysis result provided when the delay time difference Δt in the delay period DL is shorter than the period T of the wavelet pulse. FIGS. 11E and 11F explain an analysis result provided when the delay time difference Δt in the delay period DL is longer than the period T of the wavelet pulse. In FIGS. 11A to 11F, the horizontal axis indicates the time. The vertical axis in FIGS. 11A, 11C, and 11E indicates the frequency (order), and the vertical axis in FIGS. 11B, 11D, and 11F indicates the light intensity.

As shown in FIG. 11D, when the wavelet pulses overlap, the low-order components overlap, as shown in FIG. 11C. However, since the high-order components do not overlap, as shown in FIG. 11C, the delay period can be found with attention to the high-order components. In contrast, when the wavelet pulses are sufficiently separate from each other, as shown in FIG. 11F, the low-order components and the high-order components do not overlap, as shown in FIG. 11E. Hence, the delay period can be found with attention to the low-order components. From the above, a high time resolution and a high SNR can both be achieved in one pulse by performing wavelet analysis.

While wavelet analysis is conducted on the wavelet pulses reflected from the optical transmission line in this embodiment, for example, window Fourier transform may be conducted. However, wavelet analysis is preferably used because the time resolution and the frequency resolution are fixed in window Fourier transform.

### Second Embodiment

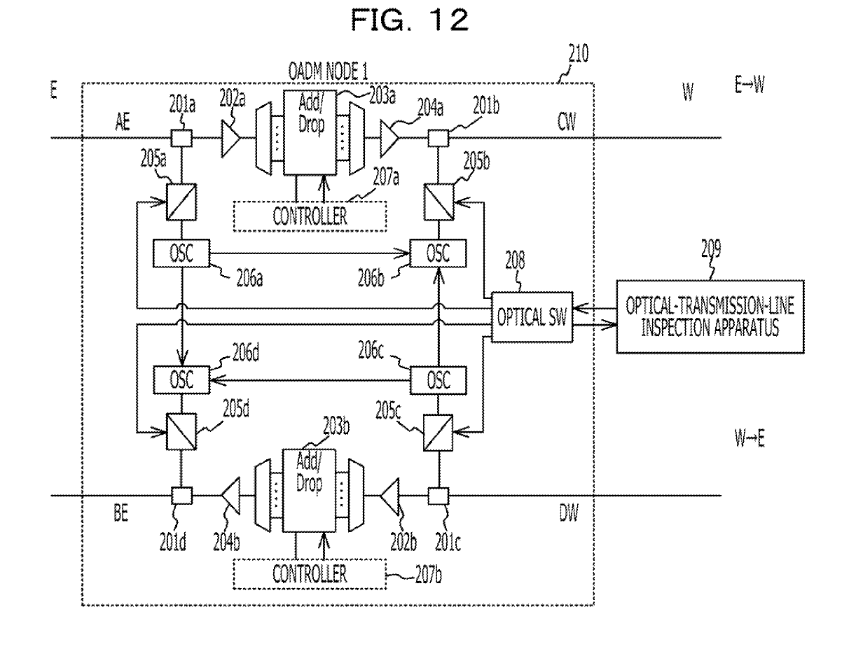

A description will be given of a second embodiment in which an optical-transmission-line inspection apparatus 100 is applied to an optical add/drop multiplexer (OADM) node 210 in an optical transmission system. FIG. 12 is a block diagram of the OADM node 210.

Referring to FIG. 12, the OADM node 210 includes splitters 201a to 201d, preamplifiers 202a and 202b, OADMs 203a and 203b, post-amplifiers 204a and 204b, optical supervisor channel (OSC) ports 205a to 205d, OSC devices 206a to 206d, controllers 207a and 207b, an optical switch 208, and an optical-transmission-line inspection apparatus 209.

The splitter 201a splits a light signal AE in a first direction (direction from E to W in FIG. 12) input from an optical transmission line of a span AE to the OADM node 210. One split light component is input to the preamplifier 202a, and the other split light component is input to the OSC device 206a via the OSC port 205a.

The preamplifier 202a amplifies and inputs the input split light component to the OADM 203a, where the input light signal is demultiplexed, subjected to add/drop control by the controller 207a, multiplexed, and then output. The post-amplifier 204a amplifies the light output from the OADM 203a, and outputs the light to an optical transmission line of a span CW via the splitter 201b.

The splitter 201c splits a light signal DW in a second direction (direction from W to E in FIG. 12) input from an optical transmission line of a span DW to the OADM node 210. One split light component is input to the preamplifier 202b, and the other split light component is input to the OSC device 206c via the OSC port 205c.

The preamplifier 202b amplifies and inputs the input split light component to the OADM 203b, where the input light signal is demultiplexed, subjected to add/drop control by the controller 207b, multiplexed, and then output. The post-amplifiers 204b amplifies and outputs the light from the OADM 203b to an optical transmission line of a span BE via the splitter 201d.

On the basis of the light signal AE input to the OSC device 206a and the light signal DW input to the OSC device 206c, the OSC device 206b transmits a light monitoring signal to the span CW via the OSC port 205b. On the basis of the light signal AE input to the OSC device 206a and the light signal DW input to the OSC device 206c, the OSC device 206d transmits a light monitoring signal to the span BE via the OSC port 205d.

The optical-transmission-line inspection apparatus 209 has a configuration similar to that of the optical-transmission-line inspection apparatus 100 of the first embodiment, and is coupled to the OSC ports 205a to 205d via the optical switch 208. The optical switch 208 switches among connections of the optical-transmission-line inspection apparatus 209 to the OSC ports 205a to 205d.

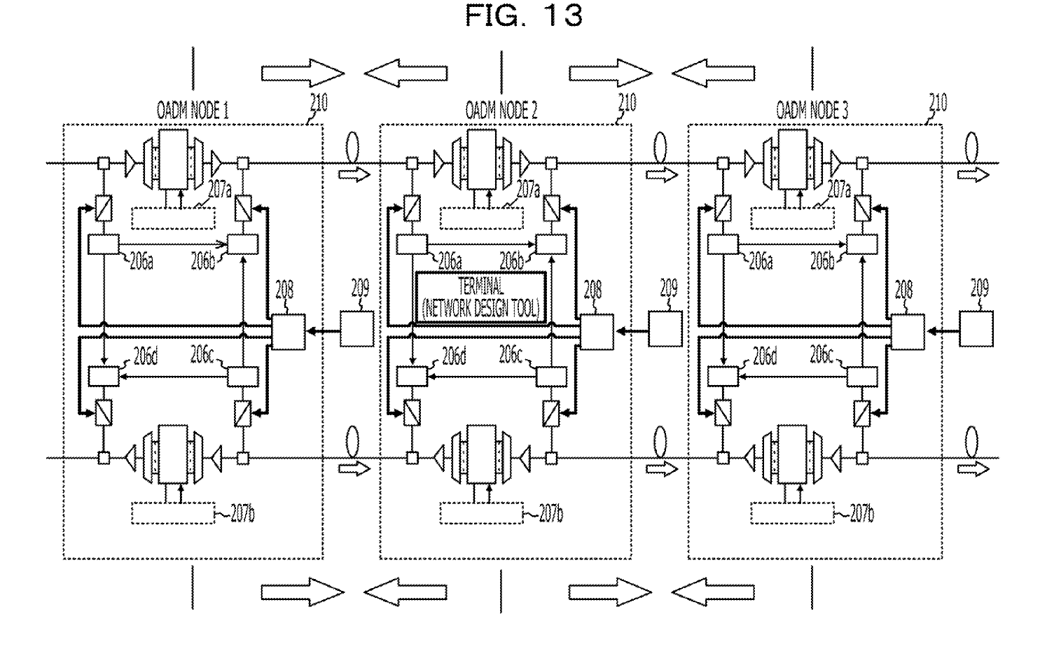

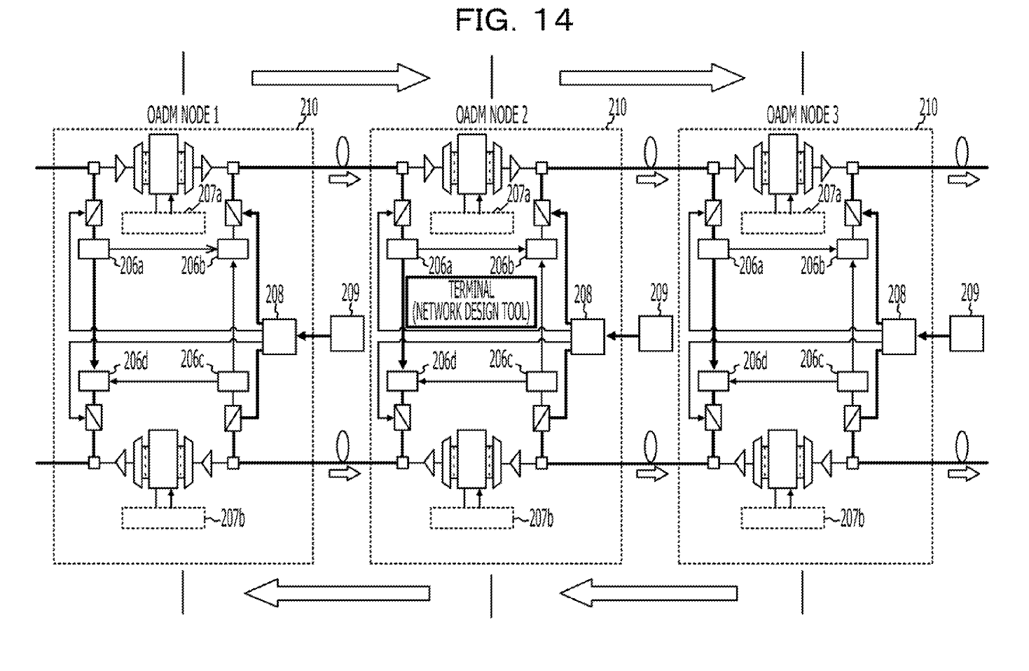

FIGS. 13 and 14 illustrate states in which a plurality of OADM nodes 210 are coupled by spans. Referring to FIG. 13, each optical-transmission-line inspection apparatus 209 can inspect spans AE, BE, CW, and DW in accordance with the connection of an optical switch 208. By conducting inspection with the OADM nodes 210, all optical transmission lines can be inspected. Since each span is coupled to both of the adjacent OADM nodes 210, it is only necessary that the optical-transmission-line inspection apparatus 209 can inspect a part corresponding to half the length of the span. Hence, the configuration shown in FIG. 13 allows inspection of a long span.

The optical switch 208 may connect the span AE and the span BE on the upstream side of the OADM node 210, or connect the span CW and the span DW on the downstream side of the OADM node 210. In this case, as illustrated in FIG. 14, each optical-transmission-line inspection apparatus 209 can simultaneously inspect the spans in the first and second directions. As a result, the number of inspection operations is reduced, and efficient inspection can be realized.

While the optical-transmission-line inspection apparatus 209 is coupled to the OSC ports in this embodiment, it is only necessary that the optical-transmission-line inspection apparatus 209 should be coupled to any portion in the optical transmission line of the optical transmission system. Further, while the optical-transmission-line inspection apparatus 209 is incorporated in the OADM node in this embodiment, for example, it may be provided independently of the units in the optical transmission system.

While the embodiments of the present invention have been in detail above, the present invention is not limited to these specific embodiments, and various modifications and alterations can be made within the scope of the invention as defined in the claims.

According to the optical-transmission-line inspection apparatus, the optical transmission system, and the optical-transmission-line inspection method disclosed in this specification, it is possible to achieve both short distance and high resolution, and long distance and low resolution in one measurement operation.

What is claimed is:

1. An optical-transmission-line inspection apparatus, comprising:
a pulse generator configured to generate a wavelet pulse defined by a setting device;
an optical modulator configured to output an optical wavelet pulse based on the wavelet pulse generated by the pulse generator to an optical transmission line; and
an analyzer configured to analyze a reflected wavelet pulse from the optical transmission line.

2. The optical-transmission-line inspection apparatus according to claim 1, wherein the analyzer conducts wavelet analysis on the wavelet pulse reflected from the optical transmission line.

3. The optical-transmission-line inspection apparatus according to claim 1, further comprising:
an operation device configured to calculate a delay period by using high-order components of the same order that do not overlap, when a delay time difference between a plurality of return pulses reflected at different reflection points is shorter than a period of the wavelet pulse generated by the pulse generator.

4. The optical-transmission-line inspection apparatus according to claim 1, further comprising:
an operation device (70) configured to calculate a delay period by using low-order components of an order other than the maximum order, when a delay time difference between a plurality of return pulses reflected at different reflection points is longer than a period of the wavelet pulse generated by the pulse generator.

5. The optical-transmission-line inspection apparatus according to claim 1, wherein the wavelet pulse includes pulse components of arbitrary two of 0- to n-orders, n being an arbitrary positive number, and wherein a time width of the n-order pulse component is 2ⁿ times a time width of the 0-order pulse component.

6. The optical-transmission-line inspection apparatus according to claim 1, wherein the product of a time width and a peak power of a pulse component of each order in the wavelet pulse is fixed.

7. The optical-transmission-line inspection apparatus according to claim 1, wherein the pulse generator gives a plus offset to the generated wavelet pulse.

8. An optical transmission system, comprising:
an optical transmission line configured to connect an optical transmitter and an optical receiver; and
an optical-transmission-line inspection apparatus coupled to any portion of the optical transmission line,
wherein the optical-transmission-line inspection apparatus includes:
a pulse generator configured to generate a wavelet pulse defined by a setting device,
an optical modulator configured to output an optical wavelet pulse based on the wavelet pulse generated by the pulse generator to the optical transmission line, and
an analyzer configured to analyze a reflected wavelet pulse from the optical transmission line.

9. The optical transmission system according to claim 8, wherein the optical-transmission-line inspection apparatus is coupled to an OSC port of a node provided in the optical transmission line.

10. The optical transmission system according to claim 9, further comprising:
an optical switch coupled between the optical-transmission-line inspection apparatus and the OSC port, the optical switch switching between connections of the optical-transmission-line inspection apparatus to a plurality of paths coupled to the node.

11. The optical transmission system according to claim 10, wherein the optical switch selects connection of an upstream span of one of the paths to a downstream span of the other path.

12. An optical-transmission-line inspection method comprising:
generating a wavelet pulse defined by a setting device;
outputting, by an optical modulator, an optical wavelet pulse based on the wavelet pulse generated in the generating to an optical transmission line; and
analyzing a reflected wavelet pulse from the optical transmission line.

13. The optical-transmission-line inspection method according to claim 12, wherein wavelet analysis is conducted on the reflected wavelet pulse from the optical transmission line in the analyzing.

14. The optical-transmission-line inspection method according to claim 12, further comprising:
calculating a delay period by using high-order components of the same order that do not overlap, when a delay time difference between a plurality of reflected return pulses reflected at different reflection points is shorter than a period of the wavelet pulse generated by the pulse generator.

15. The optical-transmission-line inspection method according to claim 12, further comprising:
calculating a delay period by using low-order components of an order other than the maximum order, when a delay time difference between a plurality of reflected return pulses reflected at different reflection points is longer than a period of the wavelet pulse generated by the pulse generator.

16. The optical-transmission-line inspection method according to claim 12,
wherein the wavelet pulse includes pulse components of arbitrary two of O- to n-orders, n being an arbitrary positive number, and
wherein a time width of the n-order pulse component is 2ⁿ times a time width of the 0-order pulse component.

17. The optical-transmission-line inspection method according to claim 12, wherein the product of a time width and a peak power of a pulse component of each order in the wavelet pulse is fixed.

18. The optical-transmission-line inspection method according to claim 12, wherein a plus offset is given to the generated wavelet pulse in the generating.
